(19) United States
(12) Patent Application Publication
(10) Pub. No.: US 2005/0156074 A1
(43) Pub. Date: Jul. 21, 2005

(54) Belt spool, in particular for a belt retractor with a belt tensioner

(75) Inventor: Franz Wier, Goeggingen (DE)

Correspondence Address: TAROLLI, SUNDHEIM, COVELL, & TUMMINO L.L.P.;1111 LEADER BLDG., 526 SUPERIOR AVENUE, CLEVELAND, OH, 44114-1400, US

(73) Assignee: TRW Automotive GmbH

(21) Appl. No.: 11/024,189

(22) Filed: Dec. 28, 2004

(30) Foreign Application Priority Data
Jan. 16, 2004 (DE) 10 2004 002 425.1

(51) Int. Cl. B60R 22/34

(52) U.S. Cl. 242/376

(57) ABSTRACT

A belt spool, in particular for a belt retractor with belt tensioner, has a spool body. The spool body has a mounting at an axial end face. A pinion is arranged on the mounting.

### BACKGROUND OF THE INVENTION

A belt spool of a belt retractor serves to hold a safety belt of a vehicle occupant restraint system and comprises a spool body. The belt tensioner serves, in case of need, to drive the belt spool in the winding direction of the safety belt, in order to remove the so-called belt slack from the safety belt system. In some known systems, a pinion is provided, which transfers a driving force of the belt tensioner to the belt spool.

The object of the invention consists in providing a simplified fastening of the pinion to the belt spool.

### BRIEF DESCRIPTION OF THE INVENTION

To solve this problem, a belt spool is provided which has a spool body. The spool body has an end face at which a mounting is provided. On the mounting, a pinion is provided. The mounting makes it possible to fasten the pinion either by insertion on the belt spool or to form the pinion in one piece on the mounting. In this way, a small structural space is produced.

Advantageous developments of the invention will be apparent from the sub-claims.

### BRIEF DESCRIPTION OF THE DRAWINGS

The invention is described below with the aid of a preferred embodiment, which is illustrated in the enclosed drawings. In these:

FIG. 1 shows a cross-section through a belt retractor with belt tensioner, a belt spool according to the invention being provided;

FIG. 2 shows a side view of the belt spool used in the belt retractor of FIG. 1;

FIG. 3 shows the view of an end face of the belt spool of FIG. 2;

FIG. 4 shows a cross-section through the belt spool;

FIG. 5 shows a section along the plane V-V of FIG. 4; and

FIG. 6 shows a section along the plane VI-VI of FIG. 4.

### DETAILED DESCRIPTION OF THE INVENTION

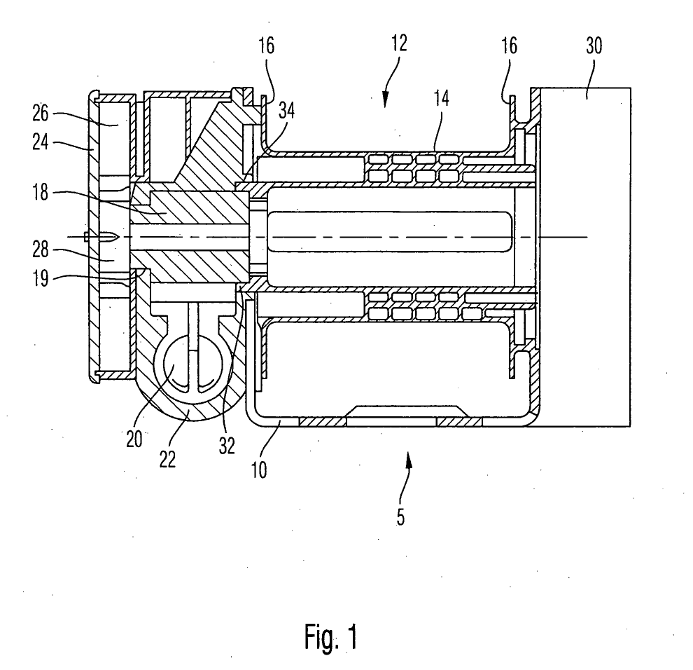

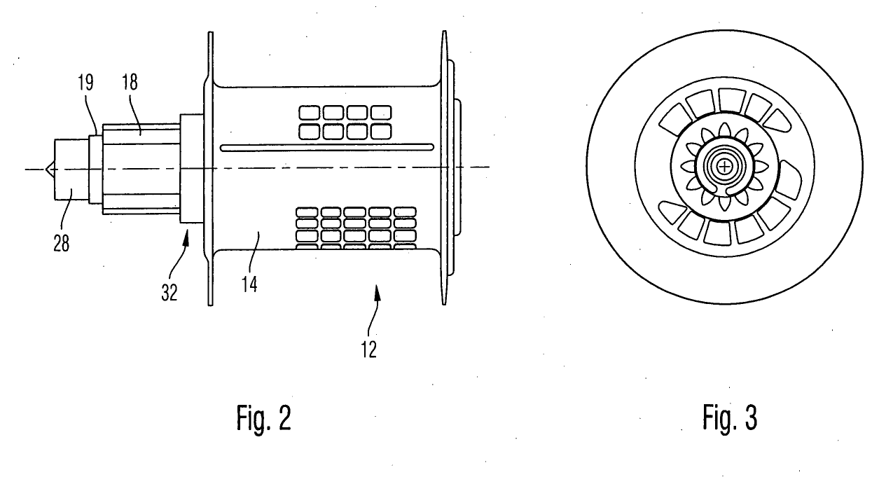

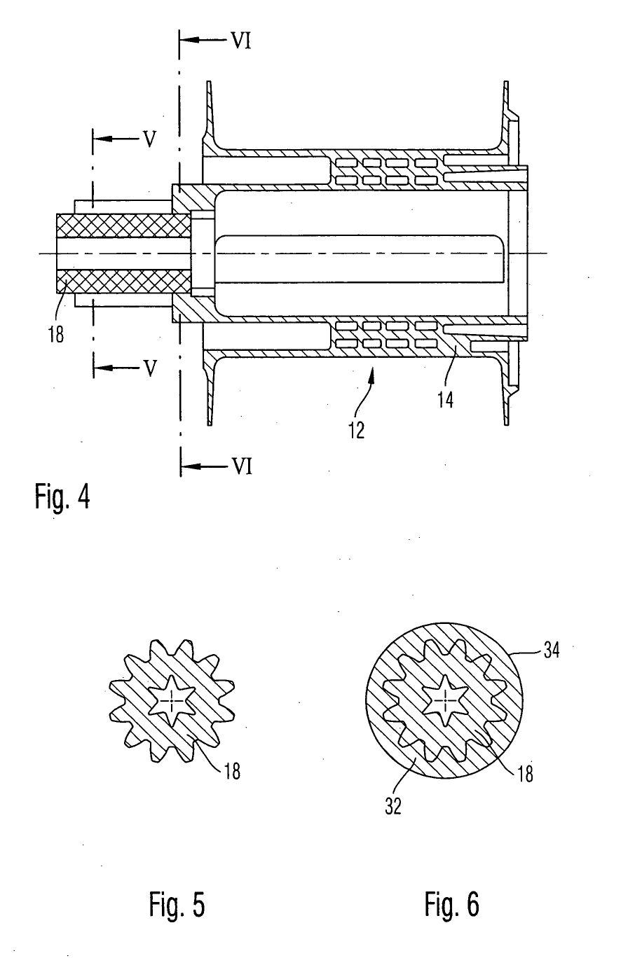

In FIG. 1 a belt retractor 5 is shown, which has a frame 10. In the frame 10, a belt spool 12 is rotatably mounted, which consists of a spool body 14, two flanges 16 and a pinion 18. A piston 20 of a belt tensioner 22 can act on the pinion 18, in order to act upon the belt spool 12 in the winding direction of the belt band. On the side of the belt tensioner 22 facing away from the spool body 14, a spring cassette 24 is arranged, which has a winding spring 26. The winding spring 26 is arranged at its inner end on a spring core 28, which is connected with the pinion 18 so as to be secure against rotation. The pinion 18 is provided on its side facing away from the mounting 32 with a bearing surface 19, which is mounted in the belt tensioner 22. On the side of the frame 10 opposite the belt tensioner drive 22, a blocking mechanism 30 is arranged, which serves to block the belt spool in a vehicle-sensitive or belt band-sensitive manner.

The belt spool 12 has on its end face, on which the pinion 18 is arranged, a mounting 32 into which the pinion 18 is inserted. The mounting 32 has an inner profile which corresponds to the profile of the teeth of the pinion 18. The mounting 32 is constructed as a collar which has a cylindrical outer surface 34. This surface serves as a bearing surface for the belt spool. It is coated with a sliding lacquer so that a slight friction with the frame 10 is produced. The use of the mounting 32 at the same time for bearing the belt spool has the advantage that the outer surface 34 of the mounting 32 is arranged in an opening of the frame 10 closely surrounding the mounting 32. If a high torque is introduced into the belt spool 12 via the pinion 18, and thereby the pinion 18 attempts to widen the mounting 32 in radial direction, the outer surface 34 of the mounting 32 can rest in the frame 10. In this way, the strength of the mounting 32 is increased.

In the embodiment shown, the pinion 18 is inserted directly into the mounting 32. As the outer profile of the pinion 18 is identical to the inner profile of the mounting 32, a play-free fit is produced. Alternatively, provision could be made that the profile of the mounting 32 is constructed so as to be greater than the profile of the pinion 18. Between the outer flanks of the pinion and the inner flanks of the mounting 32, a damping member could be arranged, so that with a high torque, a relative rotation is possible between the pinion 18 and the belt spool 12 is possible. In this way, force peaks can be damped, which can occur on activation of the belt tensioner 32. Through the damping element, the stresses which occur are reduced to such an extent that a less high-strength and hence more favourably priced material can be selected for the pinion, the teeth of the piston 20 of the belt tensioner 22 and for the belt spool 12. The spool is preferably produced as a die cast part. For cost reasons, preferably a zinc alloy is used or, for weight reasons, a magnesium alloy.

According to a further development, which is not illustrated, the pinion can also be formed in one piece onto the mounting.

The diameter of the bearing surface 34 is preferably selected to be smaller than 25 mm, in order to ensure a small friction radius. The pinion 18 has a relatively large number of teeth of at least 9 teeth. In addition, a large tip diameter of the teeth of at least 15 mm is provided, so that the retractor spool and the pinion can be produced in one piece or in two pieces. Inside the retractor spool, if required a torsion rod can be provided for force limitation.

The teeth of the pinion 18 are preferably wider than 12 mm, so that a less high-strength and hence cheaper material can be used.

1. A belt spool, in particular for a belt retractor with belt tensioner, having a spool body, said spool body comprising an axial end face, said axial end face being provided with a mounting, said mounting being provided with a pinion.

2. The belt spool of claim 1 wherein said mounting is formed as a collar.

3. The belt spool of claim 2 wherein said collar has an outer side, said outer side forming a bearing.

4. The belt spool of claim 3 wherein said outer side of said collar is coated with a sliding lacquer.

5. The belt spool of claim 1 wherein said pinion is inserted into said mounting.

6. The belt spool of claim 5 wherein said mounting has inner teeth, said pinion having teeth, said inner teeth of said mounting being complementary to said teeth of said pinion.

7. The belt spool of claim 6 wherein said pinion is held free of play in said mounting.

8. The belt spool of claim 6 wherein said pinion is held within said mounting so as to be rotatable in a damped manner.

9. The belt spool of claim 1 wherein said pinion is formed in one piece onto said mounting.

10. The belt spool of claim 1 wherein said pinion is provided with a bearing surface on the side facing away from said belt spool.

11. The belt spool of claim 1 wherein said pinion is provided with a spring core on a side facing away from said belt spool.

12. The belt spool of claim 1 wherein said spool body is a die cast element.

13. The belt spool of claim 1 wherein said pinion has teeth which have a width of more than 12 mm.

14. The belt spool of claim 1 wherein said pinion has teeth which have a tip diameter of at least 15 mm.

15. The belt spool of claim 1 wherein said pinion has at least nine teeth.
